(19) United States
(12) Patent Application Publication
(10) Pub. No.: US 2013/0287899 A1
(43) Pub. Date: Oct. 31, 2013

(54) CENTER-IN-SHELL CHEWABLE COMPOSITIONS WITH FUNCTIONAL COMPONENTS

(71) Applicant: Martin Rifkin, Vancouver, WA (US)

(72) Inventor: Martin Rifkin, Vancouver, WA (US)

(73) Assignee: Avid Health, Inc., Vancouver, WA (US)

(21) Appl. No.: 13/456,044

(22) Filed: Apr. 25, 2012

(51) Int. Cl. A23L 1/30; A23L 1/302

(52) U.S. Cl. 426/72; 426/89; 426/87

(57) ABSTRACT

Chewable compositions including an inner or center portion in the form of a liquid, semi-liquid, or gel and at least one inner functional component and including an outer or shell portion comprised of a hydrocolloid base including at least one outer functional component, wherein the inner portion is surrounded by the outer portion. In some examples, a first water activity of die shell portion and a second water activity of die center portion are similar. In some examples, the inner functional component includes a dietary supplement or drug. In still further examples, the inner portion has a volume ranging between 0.25 ml and 1.25 ml, the outer portion houses the inner portion and protects the inner functional component from exposure to oxygen and moisture, and a first density of the outer portion and a second density of the inner portion are substantially different.

### BACKGROUND

The present disclosure relates generally to chewable compositions. In particular, chewable compositions having a center-in-shell configuration and including functional components are described herein.

Dietary supplements and pharmaceuticals (collectively “supplements”) are commonly ingested orally to provide health benefits to people and animals. However, known supplements and drugs are not entirely satisfactory for the range of applications in which they are employed. For example, existing supplements are often large, hard to swallow, and generally not chewable.

Some solutions to the problems with existing supplements are chewable tablets or chewable gelatin capsules. However, some chewable tablets and chewable gelatin capsules have an unpleasant taste and an undesirable mouthfeel. Additionally, the chewable gelatin capsules require chewing to grind and break-down the gelatin capsule, which ultimately releases the generally unpleasant tasting dietary supplement or drugs. After chewing, the remaining gelatin capsule is spit out.

Some have overcome the problem of excessive chewiness, unpleasant taste, and unpleasant mouthfeel of existing supplements and drugs by incorporating the supplement within a confectionary or a gummy matrix to form a gummy supplement. While this overcomes many of the problems with conventional supplements, the delivery method using conventional gummy supplements has a limited dose of functional components, such as vitamins or pharmaceutical agents. Additionally, as the dose is increased in known gummy supplements, the gummy matrix is destroyed.

Moreover, some components of existing gummy supplements negatively impact the pH of the gummy matrix. Further, the taste, smell, texture, and other organoleptic properties of the gummy supplement are adversely affected by some useful components that would be desirable to incorporate into a gummy supplement. These limitations apparent with adding certain components to conventional gummy supplements make the resulting product less desirable from a consumer standpoint, or a manufacturing standpoint, or both. Moreover, the conventional gummy matrix does not adequately protect incorporated supplements from oxygen, moisture, and/or light.

In particular, known chewable compositions suffer from unsightly spots created by oxygen reacting with vitamin C within the chewable composition to produce furfural. Conventional solutions for combating furfural production involve using oxygen absorbers to scavenge oxygen from a sealed environment surrounding the chewable composition. However, oxygen absorbers are rendered inoperative when the sealed environment, is breached, such as when packaging is opened to access the chewable composition.

Conventional chewable compositions also do not provide satisfactory control over the dose of functional components over time. Dose control presents challenges to suppliers in their efforts to meet their label claims. Functional components in conventional chewable compositions are exposed to the environment and exposed functional components will decay at an increased rate.

Accordingly, suppliers must currently add a higher quantity of functional components to their chewable compositions than they claim on their product labels to accommodate for the increased rate of decay. Adding higher quantities of functional components increases cost and can negatively affect the makeup, taste, and texture of the chewable composition. Further, it can be difficult to determine how much extra quantity of functional components to add to accommodate for the increased rate of functional component decay.

Thus, there exists a need for chewable compositions that improve upon and advance the design of known chewable compositions. Examples of new and useful chewable compositions relevant to the needs existing in the field are discussed below.

Disclosure addressing one or more of the identified existing needs is provided in the detailed description below. References relevant: to chewable compositions include U.S. Patent References: U.S. Pat. Nos. 7,592,018, 7,211,283, 6,531,174, 7,470,119, 5,626,896, 1,711,750, 7,211,283, 6,528,102, 20100226904, 20100136185, 20090155189, 20080253976, 20080248089, 20060205682, 20060182867, 20050260329, 20070104828, and 20120035277. References relevant to depositors suitable for preparing dietary supplements include U.S. Pat. Nos. 7,470,119, 7,211,283, and 1,711,750. The complete disclosures of the above patents and patent applications are herein incorporated by reference for all purposes.

### SUMMARY

The present disclosure is directed to chewable compositions including an inner or center portion in the form of a liquid, semi-liquid, or gel and at least one inner functional component and including an outer or shell portion comprised of a hydrocolloid base including at least one outer functional component, wherein the inner portion is surrounded by the outer portion. In some examples, a first water activity of the shell portion and a second water activity of the center portion are similar, in some examples, the inner functional component includes a dietary supplement or drug. In still further examples, the inner portion has a volume ranging between 0.25 ml and 1.25 ml, the outer portion houses the inner portion and protects the inner functional component from exposure to oxygen and moisture, and a first density of the outer portion and a second density of the inner portion are substantially different.

### BRIEF DESCRIPTION OF THE DRAWINGS

FIG. 1 is a perspective schematic view of a first example of a chewable composition including an inner portion surrounded by an outer portion where the inner portion includes a functional component.

FIG. 2 is a perspective schematic view of a second example of a chewable composition including an inner portion surrounded by an outer portion, where the inner portion and the outer component each include different functional components.

FIG. 3 is a perspective schematic view of a third example of a chewable composition including an inner portion surrounded by an outer portion, where the inner portion and the outer component each include the same functional component.

FIG. 4 is a flowchart of a method for making a chewable composition including an inner portion surrounded by an outer portion.

FIG. 5 is a flowchart depicting a first mixing step of the method of FIG. 4 in more detail.

FIG. 6 is a flowchart depicting a second mixing step of the method of FIG. 4 in more detail.

FIG. 7 is a flowchart depicting a center components mixing step of the method of FIG. 4 in more detail.

FIG. 8 is a schematic view of a concentric nozzle suitable for use in the molding step of the method of FIG. 4.

### DETAILED DESCRIPTION

The disclosed chewable compositions will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations: however, for the sake of brevity, each and every contemplated variation is not individually described in the following detailed description.

Throughout the following detailed description, examples of various chewable compositions are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Chewable Composition.

With reference to FIG. 1, a chewable composition 100 will be described. Chewable composition 100 has a center-in-shell configuration and serves as a delivery vehicle for functional components. In particular, chewable composition 100 is configured to deliver a relatively large dose of functional components as compared to conventional chewable compositions.

Despite the relatively large dose of functional components delivered by chewable composition 100, it maintains the integrity of its gummy matrix. The center-in-shell configuration enables chewable composition 100 to protect functional components located in its center portion from the potentially damaging effects of oxygen, moisture, and light. Further, chewable composition 100 maintains the pH level of its gummy matrix within satisfactory levels to facilitate efficient and cost effective manufacturing of the chewable composition and to appeal to user's sense of taste, smell, and texture.

Indeed, chewable composition 100 is formulated to have a pleasant taste, smell and a desirable mouthfeel to enhance its palatability and to encourage users to ingest the functional components incorporated into chewable composition 100. In the present example, chewable composition 100 is configured to be chewed and swallowed in less than about 20 seconds to make consuming the chewable composition a generally pleasant and non-laborious undertaking. Chewable composition 100 can be formulated to impart a wide variety of flavors, aromas, textures, and colors depending on user preference.

Chewable compositions as described herein may be formed into a wide variety of shapes. FIGS. 1-3 depict one suitable shape, a sphere, for schematic simplicity. However, a wide variety of shapes are envisioned, such as dots, gumdrops, or squares. Suitable shapes are those that provide sufficient structural integrity to contain the center portion of the center-in-shell chewable composition while also providing the user with a readily consumable and pleasing shape.

Non-limiting examples of suitable shapes for the chewable composition include spheres, cubes, boxes, coin shaped compositions, gumdrop or raindrop shapes, pyramids, disks, and irregular shapes. Further suitable shapes include life-form based shapes, such as animals, including bears, worms, or fish, plants, trees, or flowers, or people. Other suitable shapes include shapes of objects, such as cars, houses, mountains, cell phones, or money.

The chewable composition may be made in a variety of sizes and weights to serve as a pleasing and appropriate supplement for different people. For example, adults may prefer a larger chewable composition whereas children may prefer a smaller chewable composition. The size and weight of the chewable composition may be varied depending on the amount of functional components to be delivered to the person ingesting the chewable composition. In some examples, the chewable composition weighs between approximately 2 grams and about 10 grams. However, heavier and lighter chewable compositions are contemplated.

With reference to FIG. 1, the reader can see that chewable composition 100 includes an inner portion 120, an outer portion 110 surrounding inner portion 120, and indicia 130 embossed on an exterior surface of outer portion 110. In this description, the inner portion will sometimes be interchangeably referred to as a center portion or center and the outer portion will sometimes be interchangeably referred to as a shell portion or shell. Likewise, the chewable composition as a whole will sometimes be interchangeably referred to as a “center-in-shell composition,” a center-in-shell supplement, supplement, a chewable hydrocolloid-based supplement, a gummy supplement, or simply a gummy.

### Inner Portion.

Inner portion 120 may be formulated into a variety of physical states to provide a variety of textures, consistencies, chewiness, and other mouthfeel characteristics. For instance, in some applications it is desirable for the inner portion to squirt or gush out of the outer portion when the user pierces the outer portion. Inner portions formulated as a liquid with a low viscosity may provide the desired gushing characteristics upon piercing the outer portion. Depending on the application and the composition of the inner portion, the inner portion may be formulated to be a liquid, a semi-liquid, or a gel matrix.

The inner portion may include a variety of components. For example, the inner portion may include functional components, water, syrups, oils, emulsifiers, flavors, colors, acids, thickeners/binders, and sweeteners among other components. In some examples, the inner portion includes water, a blend of vitamins or drugs, sucrose, and 63/43 DE glucose syrup.

Those skilled in the art will recognize that a wide variety of components may advantageously be included in the inner portion to impart various characteristics to the chewable composition. All known and later developed components suitable for chewable compositions may be included in the inner portion.

The makeup of the inner portion may be formulated to provide desired characteristics to the inner portion and to the chewable composition. A wide-variety of ratios of the components of the inner portion may be selected depending on the application.

For example, the functional components may be from about 5 to about 60 weight percent of the weight of the inner portion. Water may range from 0 to about 50 weight percent of the weight of the inner portion. In some examples, the water ranges from 15 to 21 weight percent. In a specific example, the water is approximately 18 weight percent of the weight of the inner portion.

Syrups may be present from 0 to about 75 weight percent of the weight of the inner portion. In some examples, the syrup is present in a weight percent range of 50 to 75 weight percent. In a particular example, the syrup is present as a mixture of sugar and glucose syrup, where the sugar represents approximately 29 weight percent of the inner portion and the glucose syrup represents approximately 43 weight percent.

The weight of colorants may range from about 0 to about 2 weight percent of the weight of the inner portion. The weight of thickeners and/or binders included in the inner portion may be from about 0 to about 5 weight percent of the weight of the inner portion.

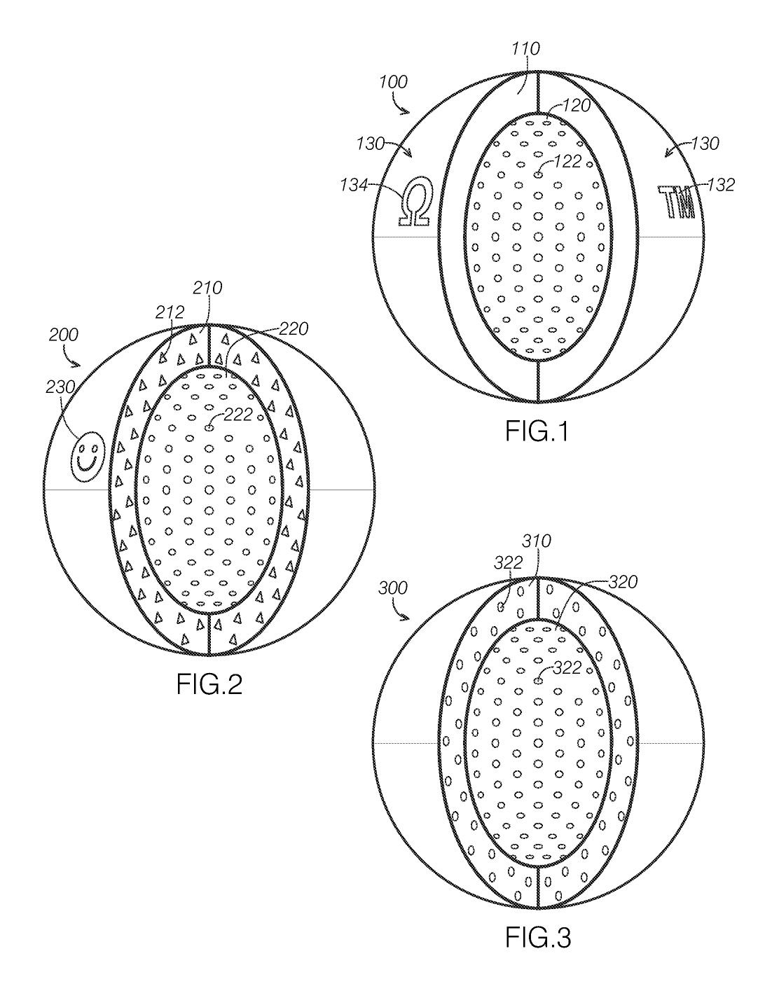

With initial consideration of functional components in the inner portion, which will be described in more detail below, the reader can see in FIG. 1 that inner portion 120 includes a functional component 122 and outer portion 110 does not include a functional component. However, in other examples of chewable compositions, such as shown in FIGS. 2 and 3, the inner portion and the outer portion may both include a functional component.

For example, FIG. 2 depicts a chewable composition 200 including an inner portion 220 with an inner functional component 222 and an outer portion 210 with an outer functional component 212. In the FIG. 2 example, inner functional component 222 and outer functional component 212 are different from one another. In particular, inner functional component 222 and outer functional component 212 are complimentary to each other.

In other examples, such as shown in FIG. 3, the inner functional component and the outer functional component are the same. With reference to FIG. 3, a chewable composition 300 includes an inner portion 320 with an inner functional component 322 and an outer portion 310 with an outer functional component 322. In the FIG. 3 example, inner functional component 322 and outer functional component 322 are the same. In particular, the inner functional component and the outer functional component may both be omega-3 fatty acid, such as docosahexaenoic acid, and in aggregate contain more than 250 milligrams of omega-3 fatty acid.

The inner portion mass, density, and volume may vary depending on a variety of factors and intended applications. For example, the volume of the inner portion may be increased or decreased to provide different taste, texture, and aroma characteristics, a desired overall chewable composition size, and/or a desired caloric intake when the chewable composition is consumed. Additionally or alternatively, the volume of the inner portion may be varied to provide a desired dose of functional components.

In some examples, the volume of the inner portion varies between 0.10 ml to 2.0 ml. In typical examples of chewable compositions described herein, the volume of the inner portion varies between 0.25 ml and 1.25 ml. A volume of 0.25 ml to 1.25 ml has been observed to provide a desired amount of functional components in a chewable composition of commercially acceptable size. Further, the inner portion volume range of between 0.25 ml and 1.25 ml is contained satisfactorily within an outer portion having relatively thin walls.

The weight of the inner portion will depend on its volume and density. The density of the inner portion may depend on the density of the outer portion. For example, the density of the inner portion may be selected to be identical to, similar to, or disparate from the density of the outer portion depending on desired taste, texture, composition, and interaction factors. In some examples, the density of the inner and outer portions is selected to help maintain the inner portion within the outer portion in a stable configuration.

To refer to the respective densities more precisely, the density of the outer portion may be defined as a first density and the density of the inner portion may be defined as a second density. The first density and die second density may be substantially different, such as different by 10% to 20% of each other. In other examples, the first density and the second density are similar to each other, such as within 10% of each other. In still further examples, the first and second densities are within 1% of each other. The first and second density may be substantially the same in some applications.

The mass of the inner portion may be selected to vary between approximately 5 to about 60 weight percent of the weight of the chewable composition. In some examples, the inner portion weighs between approximately 0.2 grams and 1.4 grams. In other examples, die inner portion weighs between approximately 1 gram and 7 grams.

The water activity of the inner portion is a property that may be selected to achieve a chewable composition with desired characteristics. In particular, the water activity of the inner portion and the water activity of the outer portion may be complimentarily formulated so that their water activities are similar.

Formulating the inner and outer portions to have similar water activities has been observed to limit components of the inner portion and the outer portion migrating between the inner portion and the outer portion. Indeed, formulating the inner and outer components to have similar water activities has been observed to help inhibit the inner portion from osmotically interacting with die outer portion. Inhibiting components from migrating between die inner and outer portions helps to restrict the inner portion from melding together with the outer portion and/or passing through the outer portion.

### Outer Portion.

As shown in FIG. 1, outer portion 110 surrounds inner portion 120 and substantially protects inner portion 120. In particular, outer portion 110 substantially protects inner portion 120 from light, oxygen, and moisture, each of which might otherwise degrade inner portion 120 in some manner. Additionally, outer portion 110 substantially protects inner portion 120 from damage during manufacturing and packaging after outer portion 110 is molded around inner portion 120. The outer portion may have insulating properties that help protect the inner portion from ambient temperatures after packaging as well.

Highlighting one aspect of its proactive characteristics, outer portion 110 inhibits furfural production within chewable composition 100, including furfural production within inner portion 120. Furfural produced from vitamin C within the chewable composition can create unsightly spots, which consumers may find unappealing. Because outer potion 110 is configured to inhibit furfural production within inner portion 120 by shielding inner portion 120 from oxygen in the surrounding air, oxygen absorbers and other techniques for scavenging oxygen are not needed. Moreover, since oxygen absorbers are effective only when the chewable composition is in a sealed package, outer portion 110 provides a better solution for inhibiting furfural production on an ongoing basis.

In the example shown in FIG. 1, outer portion 110 is formed from a hydrocolloid base. The outer portion may be comprised of functional components, thickeners or binders, gelatin, starch, water, sweeteners, oils, emulsifiers, flavors, colors, and acids. In some examples, the thickener includes a citrus pectin and sucrose mixture, such as a mixture of 1 part citrus pectin to 1 part sucrose. The sweetener may include syrups, such as 63/43 DE (dextrose equivalent) syrup, maltitol syrup, or 43/43 DE glucose syrup mixed with sucrose.

Functional components are optionally included in the outer portion. In some applications, it is desirable to include a functional component In the outer portion that is different than the functional component of the inner portion. In some examples, where different functional components are included in the inner and outer portions, the functional components are selected to be complimentary to one another, as described in more detail below. In some applications, it is desirable to include the same functional component in the outer portion as is included in the inner component, such as to increase the dose of the functional component provided by the chewable composition.

To accommodate the various different applications where functional components are advantageously included in the outer portion or advantageously not included, the inventor contemplates numerous chewable composition configurations

For instance, as depicted in FIGS. 1-3, in some examples the outer portion does not include functional components. In the example shown in FIG. 1, outer portion 110 does not include a functional component. However, inner portion 120 does include a functional component; namely, functional component 122.

In contrast, in some examples the outer portion includes a functional component that is different than the functional component included in the inner portion. For example, outer portion 210 of chewable composition 200 in FIG. 2 includes a functional component 212 that is different than functional component 222 included in inner portion 220. In the particular example shown in FIG. 2, functional component 212 is complimentary to inner portion 220. Complimentary functional component combinations are explained in more detail below.

In other examples, the outer portion includes a functional component that is the same as the functional component included in the inner portion. For example, outer portion 310 of chewable composition 300 in FIG. 3 includes a functional component 322 that is the same as functional component 322 included in inner portion 320.

The outer portion may include various components in various proportions in different examples. For instance, functional components may be from about 0 to about 35 weight percent of the weight of the outer portion, in certain examples, the functional components are approximately between 2 and 35 weight percent of the weight of the outer portion. In particular, the functional component is 4.5 weight percent in some examples.

The thickener may be from about 1 to about 4 weight percent of the weight of the outer portion. In a particular example, a pectin and sucrose mixture is used as a thickener and represents approximately 2 weight percent of the outer portion. Small amounts, such as 0.1 to 0.4 weight percent, of sodium citrate may be included in some examples,

Gelatin may be from about 2 to about 7 weight percent of outer portion 110. In a specific example, the gelatin is approximately 4 weight percent of the outer portion.

Starch may be from about 2 to about 10 weight percent of the weight of the outer portion. A starch weight percent range of 3 to 10 percent has been observed to yield highly satisfactory results. In a particular example, starch represents approximately 4 weight percent of the outer portion.

Water may be from about 15 to about 32 weight percent of the weight of the outer portion 110. In some examples, water is about 22 weight percent of the outer portion.

Sweeteners may be from about 0 to about 65 weight percent of the weight of the outer portion. In one example, the sweetener is maltitol syrup and the syrup is approximately 60 weight percent of the outer portion. In another example, the sweetener is 63/43 DE glucose and sucrose syrup and is approximately 24 weight percent of the outer portion. The 63/43 glucose represents approximately 14 weight percent of the outer portion and sucrose represents approximately 10 weight percent of the outer portion.

Maltitol syrup and 63/43 DE glucose and sucrose syrup are two examples of a sweetener that are suitable for chewable compositions described herein. Suitable sweeteners include syrup, fructose, corn syrup, and humectants, such as sorbitol, maltitol, and xylitol. Other suitable sweeteners include fruit juice, vegetable juice, fruit puree, fruit pulp, vegetable pulp, vegetable puree, fruit sauce, vegetable sauce, honey, maple syrup, molasses, corn syrup, sugar syrup, polyol syrup, hydrogenated starch hydrolysates syrup, emulsions, vegetable oil, glycerin, propylene glycol, ethanol, liqueurs, sorbitol or any other liquid sweetener, dairy-based liquids such as milk or cream, or any combination thereof. Any suitable known or later developed sweetener or combination of sweeteners may be used.

Colors may be from about 0 to about 2 weight percent of the weight of the outer portion. In a specific example, the colorants represent 0.6 weight percent of the outer portion. Suitable colors include red dye #40: yellow dye #5; yellow dye #6; blue dye #1, and combinations thereof. Colors may also include natural coloring such as black carrot, annatto, tumeric, and purple berry concentrate.

The weight percent of flavor additives relative to the weight of the outer portion may be between 0.2, and 0.14 weight percent. Suitable flavor additives (or flavorants) include natural and artificial flavoring additives. Acceptable artificial flavoring additives include mixtures of aromatic chemicals, such as methyl anthranilate and ethyl caproate. Acceptable natural flavoring additives include flavoring obtained from fruits, berries, honey, molasses, maple sugar and the like. Other suitable flavorants include sucrose, glucose syrup, corn syrup, and dextrose.

Acids may be between 0.02 and 0.20 weight percent of the weight of the outer portion. Suitable acids include citric acid, lactic acid, fumaric acid, malic acid, ascorbic acid and the like.

As shown in FIGS. 1 and 2, the outer portion may be embossed with indicia on its outer surface. For example, in FIG. 1, outer portion 110 is embossed with indicia 130 on its outer surface. In particular, outer portion 110 is embossed with a first indicator 132 in the form of an omega symbol and a second indicator 134 in the form of a trademark notice symbol. In the FIG. 2 example, outer portion 210 is embossed with indicator 230 in the form of a smiley face. In some examples, such as shown in FIG. 3, the outer surface is not embossed with indicia.

The indicia embossed on the outer surface may serve a variety of functions. For example, the indicia may provide information about the contents of the chewable composition, including the functional components of the chewable composition. In the FIG. 1 example, second indicator 134 depicts an omega symbol to communicate that chewable composition 100 includes an omega-3 fatty acid, such as docosahexaenoic acid.

indicia may also provide information about the supplier of the chewable composition. In the FIG. 1 example, first indicator 132 represents a trademark corresponding to a supplier of the chewable composition. Additionally or alternatively, the indicia may serve an aesthetic role or encourage children to ingest the chewable composition. For example, indicator 230 in FIG. 2 is a whimsical smiley face that may appeal to children and encourage them to consume chewable composition 200, which serves as a delivery vehicle for inner functional component 222 and outer functional component 212.

### Functional Components.

The functional components included in the inner portion and/or in the outer portion may include any combination of vitamins, minerals, antioxidants, soluble and insoluble fiber. herbs, plants, amino acids, digestive enzymes, macronutrients, micronutrients, or any other supplements digested to promote the health and well-being of a person. Additionally or alternatively, the functional components may include a pharmaceutical compound and/or an over-the-counter (OTC) drug. As used herein, a “pharmaceutical compound” or “drug” shall include, but is not limited to, any drug, hormone, peptide, nucleotide, antibody, or other chemical or biological substances used in the treatment or prevention of disease or illness, or substances which affect the structure or function of the body.

The reader should understand that functional component as used herein is not limited to a single functional component. Rather, functional component may refer to multiple functional components and/or mixtures, suspensions, slurries, or solutions of functional components despite the singular form of the term functional component. Dose of functional components may be generally expressed in terms of grams, milligrams, micrograms, active units, or international units (IU).

As used herein, reference to vitamins may include, but is not limited to, any of the following: Vitamin A (Beta-Carotene), Vitamin B Complex, Vitamin B1 (Thiamine), Vitamin B2 (Riboflavin), Vitamin B3 (Niacin), Vitamin B5 (Pantothenic Acid), Vitamin B6 (Pyridoxine), Vitamin B12 (Cyanocobalamin), Biotin, Choline, Folic Acid, Inositol, PABA (Para-Aminobenzoic Acid), Vitamin C (Ascorbic Acid), Vitamin D, Vitamin E, Vitamin K, fiber-polydextrose, Bioflavonoids, and/or Coenzyme Q10, and the like, in liquid or powder form.

As used herein, reference to minerals may include, but is not limited to, any of the following; Calcium, Chromium, Copper, Iodine, Iron, Magnesium, Manganese, Molybdenum, Potassium, Selenium, and/or Zinc, and the like, in liquid or powder form.

As used herein, reference to pharmaceutical compound, OTC, or drug may include, but is not limited to, any of the following: an opioid analgesic agent (e.g., as morphine, hydromorphone, oxymorphone, levopbanol, methadone, meperidine, fentanyl, codeine, hydrocodone, oxycodone, propoxyphene, buprenorphine, butorphanol, pentazocine and nalbuphine); a non-opioid analgesic agent (e.g., acetylsalicylic acid, acetaminophen, ibuprofen, ketoprofen, indomethacin, diflunisol, naproxen, ketorolac, dicblophenac, tolmetin, sulindac, phenacetin, piroxicam, and mefamanic acid); an anti-inflammatory agent (e.g., glucocorticoids such as aclometasone, fluocinonide, methylprednisolone, triamcinolone and dexamethasone; and non-steroidal anti-inflammatory drugs such as celecoxib, deracoxib, ketoprofen, lumiracoxib, meloxicam, parecoxib, rofecoxib, and valdecoxib); an antitussive agent (e.g., dextromethorphan, codeine, hydrocodone, caramiphen, carbetapentane, and dextromethorphan); an antipyretic agent (e.g., acetylsalicylic acid and acetaminophen); an antibiotic agent (e.g., aminoglycosides such as, amikacin, gentamicin, kanamycin, neomycin, netilmicin, streptorycin, and tobramycin; carbecephem such as loracarbef; carbapenems such as certapenem, imipenem, and meropenem; cephalosporins such as cefadroxil cefazolin, cephalexin, cefaclor, cefamandole, cephalexin, cefoxitin, cetprozil, cefuroxime, cetftazidime, cefdinir, cefditoren, cetoperazone, cefotaxime, cetpodoxime, ceftazidime, ceftibuten, ceftizoxime, and ceftriaxone; macrolides such as azithromycin, clarithromycin, dirithromycin, erythromycin and troleandomycin; monobactam, penicillins such as amoxicillin, ampicillin, carbenicillin, cloxacillin, dicioxacillin, nafilciliin, oxacillin, penicilin G, penicillin V, piperacillin, and ticarcillin; polypeptides such as bacitracin colstin, and polymycin B; quinolones such as ciprofloxacin, enoxacin, gatifloxacin, levofloxacin, ometloxacin, moxfolxacin, norfloxacin, ofloxacin and trovatioxacin, sulfonamides such as mafenide sulfacetamide, sulfamethizole, sulfasalazine, sulfisoxazole, and trimethoprim-sulfamethoxazole; and tetracyclines such as demeclocycline, doxycycline, minocycine, and oxytetracycline); an antimicrobial agent (e.g., ketoconazole, amoxicillin, cephalexin, miconazole, econazole, acyclovir, and nelfinavir); a steroidal agent (e.g., estradiol, testosterone, cortisol, aldosterone, prednisone, and cortisone); an amphetamine stimulant agent (e.g., amphetamine); a non-amphetamine stimulant agent (e.g., metbylphenidate, nicotine, and caffeine); a laxative agent (e.g., bisacodyl, casanthranol, senna, and castor oil); an anorexic agent (e.g., fenfluramine, dexfenfluramine, mazindol, phentermine, and aminorex); an antihistamlnic agent (e.g., phencarol, cetirizine, cinnarizine, ethamidindole, azatadine, brompheniramine, hydroxyzine, and chlorpheniramine); an antiasthmatic agent (e.g., zileuton, montelukast, omalizumab, fluticasone, and zafirlukast); an antidiuretic agent (e.g., desmopressin, vasopressin, and lypressin); an antiflatulant agent (e.g., simethicone); an antimigraine agent (e.g., naratriptan, frovatriptan, eletriptan, dihydroergotamine, zolmitriptan, almotriptan, and sumatriptan); an antispasmodic agent (e.g., dicyclomine, hyoscyamine, and peppermint oil); an antidiabetic agent (e.g., methformin, acarbose, miglitol, pioglitazone, rosiglitazone, troglitazone, nateglinide, repaglinide, mitiglinide, saxagliptdn, sitagliptine, vildagliptin, acetohexamide, chlorpropamide, gliclazide, glimepiride, glipizide, glyburide, tolazamide, and tolbutamide); an antacid (e.g., aluminium hydroxide, magnesium hydroxide, calcium carbonate, sodium bicarbonate, and bismuth subsalicylate); a respiratory agent (e.g., albuterol, ephedrine, metaproterenol, and terbutaline): a sympathomimetic agent (e.g., pseudoephedrine, phenylephrine, phenylpropanolamine, epinephrine, norepinephrine, dopamine, and ephedrine); an H₂ blocking agent (e.g., cimetidine, famotidine, nizatidine, and ranitidine); an antihyperltpidemic agent (e.g., clofibrate, cholestyramine, colestipol, fluvastatin, atorvastatin, genfibrozil, lovastarin, niacin, pravastatin, fenofibrate, colesevelam, and simvastatin); an antihypercholesterol agent (e.g., lovastatin, simvastatin, pravastatin, fluvastatin, atorvastatin, cholestyramine, colestipol, colesevelam, nicotinic acid, gemfibrozil, and ezetimibe); a cardiotonic agent (e.g., digitalis, ubidecarenone, and dopamine); a vasodilating agent (e.g., nitroglycerin, captopril, dihydralazine, diltiazem, and isosorbide dinitrate); a vasocontricting agent (e.g., dihydroergotoxine and dihydroergotamine); a sedative agent (e.g., amobarbital, pentobarbital, secobarbital, clomethiazole, diphenhydramine hydrochloride, and alprazolam); a hypnotic agent (e.g., zaleplon, zolpidem, eszopiclone, zopiclone, chloral hydrate, and clometbiazole); an anticonvulsant agent (e.g., lamitrogene, oxycarbamezine, pheytoin, mephenytoin, ethosuximide, methsuccimide, carbamazepine, valproic acid, gabapentin, topiramate, felbamate, and phenoharbital); a muscle relaxing agent (e.g., baclofen, carisoprodol, chlorzoxazone, cyclobenzaprine, dantrolene sodium, metaxalone, orphenadrine, pancuronium bromide, and tizanidine); an antipsychotic agent (e.g., phenothiazine, chlorpromazine, fluphenazine, perphenazine, prochlorperazine, thioridazine, trifluoperazine, haloperidol, droperidol, pimozide, clozapine, olanzapine, risperidone, quetiapine, ziprasidone, melperone, and paliperidone); an antianxiolitic agent (e.g., lorazepam, alprazolam, clonazepam, diazepam, buspirone, meprobamate, and flunitrazepam); an antihyperactive agent (e.g., methylphenidate, amphetamine, and dextroamphetamine); an antihypertensive agent (e.g., alpha-methyldopa, chlortalidone, reserpine, syrosingopine, rescinnamine, prazosin, phentolamine, felodipine, propanolol, pindolol, labetalol, clonidine, captopril, enalapril, and lisonopril); an anti-neoplasia agent (e.g., taxol, actinomycin, bleomycin A₂, mitomycin C, daunoruhicin, doxorubicin, epirubicin, idaruhicin, and mitoxantrone); a soporific agent (e.g., zolpidem tartrate, eszopiclone, ramelteon, and zaleplon); a tranquilizer (e.g., alprazolam, clonazepam, diazepam, flunitrazepam, lorazepam, triazolam, chlorpromazine, fluphenazine, haloperidol, loxapine succinate, perphenazine, prochlorperazine, thiothixene, and trifluoperazine); a decongestant (e.g., ephedrine, phenylephrine, napbazoline, and tetrahydrozoline); a beta blocker (e.g., levobunolol, pindolol, timolol maleate, bisoprolol, carvedilol, and butoxamine); an alpha blocker (e.g., doxazosin, prazosin, phenoxybenzamine, phentolamine, tamsulosin, alfuzosin, and terazosin); a non-steroidal hormone (e.g., corticotropin, vasopressin, oxytocin, insulin, oxendolone, thyroid hormone, and adrenal hormone); a herbal agent (e.g., glycyrrbiza, aloe, garlic, nigella satrva, rauwolfia, St John's wort, and valerian); an enzyme (e.g., lipase, protease, amylase, lactase, lysozyme, and urokinase); a humoral agent (e.g., prostaglandins, natural and synthetic, for example, PGE₁, PGE₂alpha, and PGF₂alpha, and the PGE₁ analog misoprostol); a psychic energizer (e.g., 3-(2-aminopropy)indole and 3-(2-arcunobutyl)indole); a vitamin (e.g., retinol, retinal, retinoic acid, 3-dehydroretinol, thiamine, riboflavin, niacin, pantothenic acid, pyridoxine, biotin, folic acid, cyanocobalamin, ascorbic acid, lumisterol, ergocalciferol, cholecalciferol, dihydrotachysterol, tocopherol, and naphthoquinone); a mineral (e.g., calcium, iron, zinc, selenium, copper, iodine, magnesium, phosphorus, and chromium); an anti-nausea agent (e.g., dolasetron, granisetron, ondansetron, tropisetron, meclizine, and cyclizine); a hematinic agent (e.g., ferrous salts, ferrous amino chelates, ferrous sulfate, ferrous fumarate, Ferrochel iron); a nutritional product (e.g., bee pollen, bran, wheat germ, kelp, cod liver oil, ginseng, and fish oils, amino acids, proteins, and mixtures thereof); and a fiber product (e.g., cellulose, lignin, polydextrose, prebiotics, waxes, chitins, pectins, beta-glucans, inulin, and oligosaccharides.

Additionally or alternatively to the foregoing, with regard to over-the-counter (OTC) drugs, the functional components may include any of the following brand name or generic equivalent drugs: Benadryl®, Sudafed®, Claritin®, Maalox®, Mylanta®, Insulin, Tums®, Pepcid® AC, Monistat®, Ex-Lax®, Imodium® A.D., Robitussin®, Chloraseptic®, Thera-Flu®, Alka-Seltzer, Motrin®, Drarnamine®, and the like, in liquid or powder form.

In another implementation, the pharmaceutical compound may include a prescription drug. Such prescription drugs such may include brand name or generic forms of Lipitor®, Singulair®, Lexapro, Plavix®, Morphine, Hydrocodone (Vicodin®), Demerol®, Codeine, Diazepam (Valium®), Penicillin, Prevacid®, Allegra-D®, Celebrex®, Crestor®, Cialis®, Valtrex®, Viagra®, Cialis®, Prilosec®, Lipitor®, Ambien CR®, Viagra®, Flomax®, Prozac®, and the like, in liquid or powder form. In these implementations, in addition to an active pharmaceutical ingredient, the active ingredients of the delivery system may also include a combination of dietary supplements. Including dietary supplements with pharmaceutical compounds will depend in part on the supplements compatibility with the pharmaceutical compound.

Other suitable functional components include and/or may be alternatively described as Acai Berry Extract, Aloe Powder, Althea Root (Marshmallow), Apple Fiber Powder, Astragalus Root, Barley Grass, Bee Pollen Powder, Beta Carotene, Betatene, Billberry Extract, Bing Cherry Powder, Biofirm, Black Cohosh, Black Currant Extract, Blackberry Powder, Blueberry Powder, Boron (Boron Citrate), Broccoli Powder, Bromelain, Burdock Root, Cabbage Powder, Caffeine (Caffeine Anhydrous), Calcium (Calcium Ascorbate), Calcium (Calcium Carbonate), Calcium (Calcium Gluconate), Calcium (Calcium Lactate), Calcium (Calcium Silicate), Calcium Citrate, Carrot Powder, Cauliflower Powder, Chamomile Extract, Chloreila, Choline (Choline Bitartrate), Choline (Choline Chloride), Chondroitin Sulfate, Chromium (Chromium Chelate), Chromium (Chromium Picolinate), Cinnamon Bark, Citrus Bioflavonoid, Coconut Oil (deoderized), Coffeeberry Powder, Collagen Peptides, Copper Chelate, CoQ10, Cranberry Powder, Echinacea Power, Elderberry Powder, Fiber (Fibersol), Fiber (Frutalose), Fiber (Polydextrose), Fiber (Raftilose), Flaxseed, GABA, Gamma Oryzanol, Ginkgo Biloba Powder, Ginseng (Korean Red Ginseng), Glucaosmine (Glucosamine HCl), Glucosamine Sulfate, Grape Seed Extract, Guarana Extract, I-Cysteine, I-Glutamine, I-Glycine, I-Isoleucine, I-Leucine, I-Lycine, I-Methionine, Inosine, Inositol (Inositol Nicotinate), Iodine (Potassium Iodide), Iron, I-Taurine, I-Tyrosine, I-Valine, Kale Powder, Kelp Powder, Kola Nut, L-Camitine, Lemon Balm Extract, Lemon Grass Powder, L-Glutamine, L-Lysine, L-Taurine, L-Theanine, L-Tyrosine, Lutein, Lutein (Floraglo), Lycopene (Lyconat), Lycopene (Redivivo), Magnesium (Gluconal Magnesium), Magnesium (Magnesium Aspartate), Magnesium (Magnesium Citrate), Maitake Powder, Manganese (Manganese Amino Acid Chelate), Manganese (Manganese Sulfate), Mango Powder, Mangosteen Extract, Mate Extract, Melatonin, Molybdenum (Molbdenum Citrate), N-Acetyl-L-Cysteine, Natural Egg Shell Membrane, Nickel (Nickel Amino Acid Chelate), Oat Straw Extract, Orange Crystals, Papain, Papaya Powder, Passion Flower Extract, Peptan, Phaseolamin, Phytosterois (Emulsified), Pineapple Powder, Pomegranate Powder, Potassium (Potassium Ascorbate), Potassium (Potassium Iodide), Probiotic Powder, Prune Powder, Psyllium Seed Husks, Rosehips, Salt, Sea Buckthorn Powder, Selenium (Amino Acid Chelate), Selenium (Sodium Selenate), Shephards Purse, Slippery Elm Bark, Spinach Powder, Spirulina Powder, Strawberry Powder, Sweet Apple Powder, Tomato Powder, Vanadium (Vanadium Citrate), Vitaberry Powder, Vitamin A Palmitate (Retinol), Vitamin B1 (Thiamin Mononitrate), Vitamin B1 Encapsulated (Thiamin), Vitamin B12 (Cobaiamin), Vitamin B2 (Riboflavin), Vitamin B2 Encapsulated (Riboflavin), Vitamin B3 (Niacin), Vitamin B3 (Niacinamide), Vitamin B5 (Calcium Pantothenate), Vitamin B6 (Pyridoxal Phosphate), Vitamin B6 Encapsulated (Pyrodoxil Phosphate), Vitamin B7 (Biotin), Vitamin B9 (Folic Acid), Vitamin C (Ascorbic Acid), Vitamin C (Calcium Ascorbate), Vitamin C (Potassium Ascorbate), Vitamin C (Sodium Ascorbate), Vitamin D3 (Ergocalciferol), Vitamin E (Novatol), Vitamin E Acetate (Alpha Tocopherol), Vitamin K1, Wellberry Fruit Extract, Wheat Grass Powder, White Willow, Wild Yam Root Powder, Xylitol, Zinc (Zinc Citrate Dihydrate), Zinc (Zinc Gluconate), Zinc Sulfate, Ω-3 Oil (Algae), Ω-3 Oil (Chia Seed), Ω-3 Oil (Fish), Ω-3 Oil (Flaxseed), Ω-3 Powder (Fish).

The above list of functional components is not exhaustive, but is provided for illustrative purposes only. A few specific examples of suitable inner functional components will be provided to demonstrate certain chewable composition formulations.

In one example, the inner functional component is vitamin C and the outer portion inhibits furfural being produced from oxidation reactions with the vitamin C. In another example, the inner portion and the outer portion include omega-3 fatty acid, including docosahexaenoic acid, as a functional component and the chewable composition provides a total dose of omega-3 fatty acid exceeding 250 milligrams collectively between the inner and outer portions. In a further example, the functional component is heat sensitive and its potency is reduced at temperatures greater than 240° F. In such examples, the heat sensitive functional component may be incorporated into the chewable composition slurry, including in the Inner portion slurry, after the slurry is cooked. One of the inventor's prior patent applications, US Patent Publication No. 20100003390, discusses methods for adding functional components to hydrocolloid bases that require cooking and is incorporated herein by reference.

The chewable compositions described herein may include combinations of functional components that complement each other. Complementary functional components have a more beneficial combined effect than the sum of the individual functional components acting alone. In one example, the inner portion includes a first functional component that complements a second functional component included in the outer portion. In other examples, the inner portion includes a combination of functional components that complement each other. Additionally or alternatively, the outer portion may include a combination of functional components that complement each other.

The following is a non-exhaustive list of functional components that are complementary: Calcium and Magnesium; Vitamins C and E; Selenium and Vitamin E; Folic Acid and B Vitamins; Zinc and Copper; Vitamin A and Choline, essential fatty acids, zinc, vitamins C, D, and E; Vitamin B complex and Calcium, vitamins C and E; Vitamin B1 (thiamine) and Manganese, vitamin B complex, vitamins C and E; Vitamin B2 (riboflavin) and Vitamin B complex, vitamin C; Vitamin B3 (niacin) and Vitamin B complex, vitamin C; Pantothenic acid (vitamin B5) and Vitamin B complex, vitamins A, C and E; Vitamin B6 (pyridoxine) and Potassium, vitamin B complex, vitamin C; Biotin and Folic acid, vitamin B complex, vitamin B5; Choline and Vitamin B complex, vitamin B12, folic acid, Inositol; Inositol and Vitamin B complex, vitamin C; PABA and Vitamin B complex, folic acid, vitamin C; Vitamin C and Bioflavonoids, calcium, magnesium; Vitamin D and Calcium, choline, essential fatty acids, phosphorus; Vitamin E and Essential fatty acids, manganese, selenium, vitamin A, vitamin B1, Inositol, vitamin C; Essential fatty acids and Vitamins A, C, D, and E.

Persons having ordinary skill in the art will understand the benefits of the above combinations. However, a few of the complementary combinations are worth some further discussion. For example, calcium taken in combination with magnesium helps with the absorption of calcium. When calcium and magnesium are taken together, they collectively help address health problems resulting from under-absorption of calcium, such as arthritis, osteoporosis, menstrual cramps, and some premenstrual symptoms.

In one embodiment, the inner functional component includes magnesium and the outer functional component includes calcium. Either or both the inner functional component and the outer functional component may further include Vitamin D, which also promotes calcium absorption.

Another complementary combination of interest is vitamin C (ascorbic acid) combined with vitamin E. Vitamin C and Vitamin E are more beneficial when taken together rather than alone. Notably, vitamin C is heat sensitive and both vitamins C and E are sensitive to oxygen and light.

In one embodiment, the inner portion includes a combination of vitamins C and E. The vitamins may be included in the inner portion after the inner portion is cooked to protect the C and E vitamins from heat. Further, including vitamins C and E in the inner portion enables the outer portion to help protect the vitamins from exposure to light and oxygen by surrounding the inner portion.

Moreover, vitamin C incorporated into a conventional confectionary or gummy matrix can lower the pH and make controlling the pH of the finished product challenging. This is especially true when making a product with high doses of vitamin C, such as a product with greater than 200 mg of vitamin C. Additionally, products with high doses of vitamin C may exhibit foaming.

Controlling pH is important from a manufacturing and consumer appeal standpoint because a low pH product has trouble holding its form, which makes it hard to bottle the product. The pH is generally not important from an efficacy standpoint.

Another benefit of placing vitamin C in the inner portion rather than the outer portion of the chewable composition is avoiding an impact on the pH of the outer portion of the chewable composition. With a conventional confectionary or gummy matrix a high dose of vitamin C will lower the pH of the confectionary or gummy matrix. A confectionary or gummy matrix with ascorbic acid and low pH will promote the production of furfural, which results in unsightly black spots or pock mocks. This can lead to an unsightly product even though the efficacy is unaffected. This combined with the heat sensitivity of vitamin C can make a high potency vitamin C product difficult to manufacture because higher doses of vitamin C are required to obtain a high potency confectionary.

Additional examples of chewable compositions including complementary functional components include those with folic acid and B vitamins and those with zinc and copper. Folic acid is especially important for pregnant women during the first trimester and works best when taken in combination with B6 and B12 vitamins. Zinc is recognized as helping the body overcome the cold and the flu. However, the body requires a certain amount of copper to utilize zinc's beneficial effects. Thus, chewable compositions, such as those just described, including complementary combination of functional components provide synergistic benefits.

In one example, the chewable composition includes multiple functional components. For example, the chewable composition may include one or more functional components in an amount corresponding to approximately 10% of the recommended daily value of a given functional component.

To achieve the foregoing and by way of non-limiting examples only, the chewable composition may include one or more of the following functional components with at least the following amounts: 350 mg of potassium, 2.5 g of dietary fiber, 5 g of protein, 500 International Units (IU) of vitamin A, 6 mg of vitamin C, 100 mg of calcium, 1.8 mg of iron, 40 IU of vitamin D, 3 IU of vitamin E, 8 micrograms (μg) of vitamin K, 0.15 mg of thiamin, 0.17 mg of riboflavin, 2 mg of niacin, 0.2 mg of vitamin B6, 40 μg of folate, 0.6 μg of vitamin B12, 30 μg of biorin, 1 mg of pantothenic acid, 100 mg of phosphorus, 15 μg of iodine, 40 mg of magnesium, 1.5 mg of zinc, 7 μg of selenium, 0.2, mg of copper, 0.2 mg of manganese, 12 μg of chromium, 7.5 μg of molybdenum, 34 mg of chloride, and 16 mg of a blend of omega-3 fatty acid esters. The blend of omega-3 fatty acid esters may have various proportions of DHA, ALA, and EPA. In one example, the omega-3 fatty-acid ester blend may include all DHA, and in another the blend may include 50% DHA and ALA.

As already discussed, in some examples, the inner portion and the outer portion of the chewable composition may include the same functional components. Additionally or alternatively, the inner portion and the outer portion of the chewable composition may include different functional components. For example, functional components sensitive to light, heat, and/or oxidation may be included solely in the center portion. For example, the functional components included solely in the inner portion may include liquid or powder forms of the following functional components: vitamin C, vitamin D, folic acid, and/or a blend of omega-3 fatty acid esters.

In some examples, the multiple functional components may include a combination of vitamins and drugs, such as combining aspirin and vitamin C. For example, a chewable composition may include 30 mg of aspirin and 30 mg of vitamin C. A complimentary effect may result from taking equal doses of vitamin C and aspirin as the combination may decrease stomach damage that occurs when taking aspirin alone.

### Methods of Making Chewable Compositions

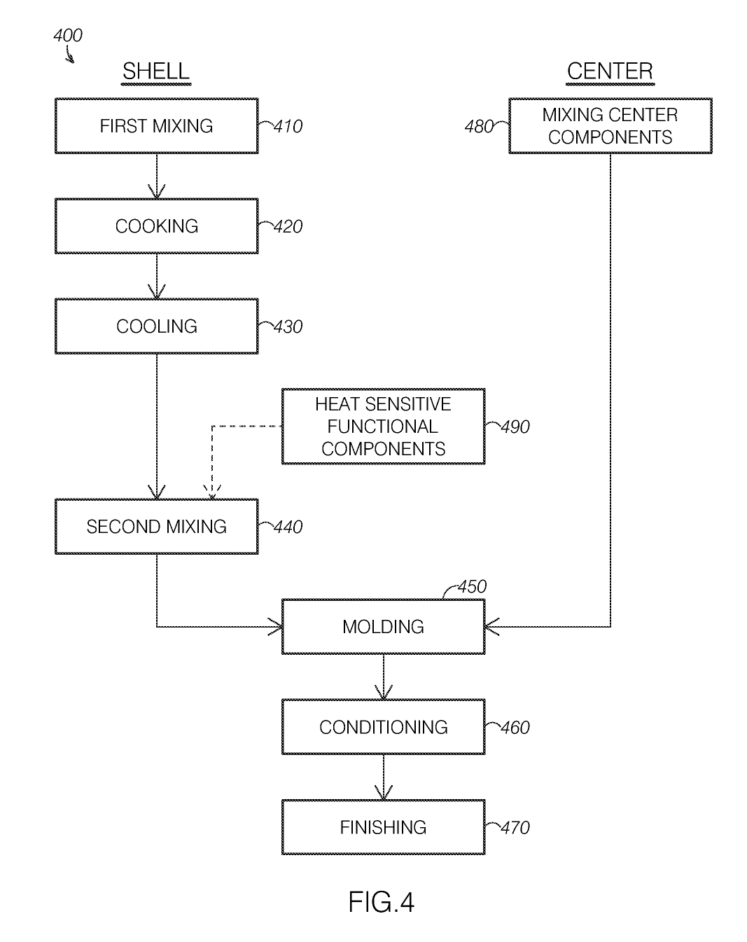

With reference to FIGS. 4-7, a method 400 of making chewable compositions described herein will be described. Method 400 may be utilized on various scales, including at a laboratory bench scale, at a pilot plant scale, at a small batch manufacturing scale, or at a bulk manufacturing scale. In one example, method 400 includes a 440 kg batch of the shell portion and a 50 kg batch of the center portion. Depending on throughput needs and equipment selected, method 400 may be run as a batch process, a semi-batch process, a semi-continuous process, or a continuous process.

As shown in FIG. 4, method 400 includes a shell portion process, beginning at step 410, and a center portion process, beginning at step 480, that merge together at a molding step 450. The shell portion process and the center portion process may occur concurrently or at separate times. For example, the center portion process may be run independent of the shell portion process to make a batch of the center portion or vice versa. The batch of the center portion or the shell portion may be stored for later use at step 450 to be molded with the other portion.

In the description below, all percentages listed for shell portion components will represent the weight percent of the specified component to the overall formula weight of the shell portion, unless otherwise specified. Likewise, the percentages listed for center portion components will represent the weight percent of the specified component to the overall formula weight of the center portion, unless otherwise specified.

With reference to FIG. 4, method 400 includes a first mixing step 410, a cooking step 420, a cooling step 430, a second mixing step 440, a molding step 450, a conditioning step 460, and a finishing step 470. Method 400 also includes mixing together center portion components at step 480. Method 400 further includes an optional step 490 of adding heat sensitive functional components to the shell slurry after the shell slurry is cooked at step 420 and cooled at step 430.

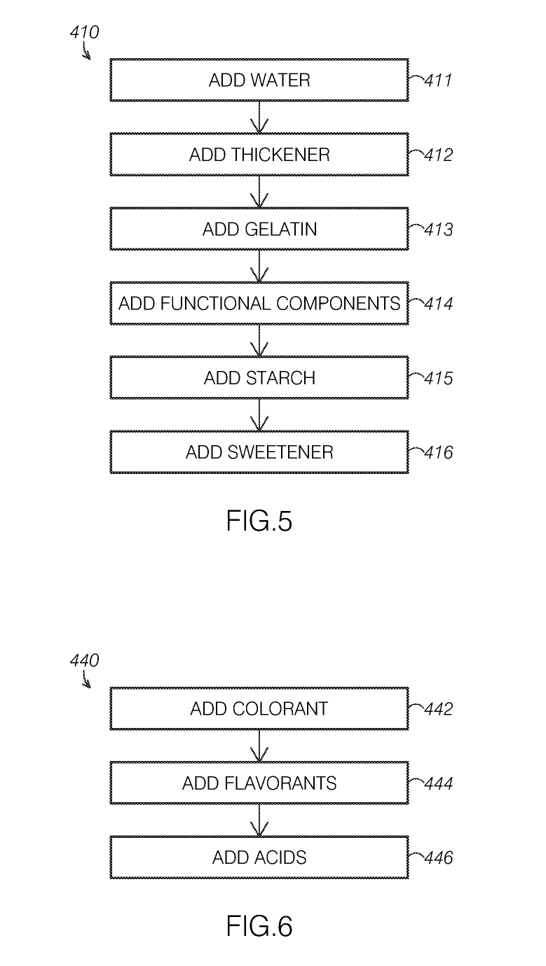

Turning attention to FIG. 5, first mixing step 410 will be described in more detail. As shown in FIG. 5, first mixing step 410 includes adding water at step 411, adding a thickener at step 412, adding gelatin at step 413, adding functional components at step 414, adding starch at step 415, and adding a sweetener at step 416. In some examples, steam jacketed kettles and transfer lines are maintained at 180-200° F. throughout first mixing step 410 and second mixing step 440.

Adding water at step 411 may include heating the water to around 185° F., which has been observed to help mix together the components added at step 410. The amount of water added at step 411 may be between 15% and 30%. In particular, water in the amount of approximately 20% may be added in certain examples.

At step 412, a thickener is added to the water to form an outer portion or shell portion slurry. In the present example, the thickener is a citrus pectin and sucrose mixture. However, any suitable known or later developed thickener may be used. In the example shown in FIG. 5, the amount of the thickener added at step 412 is 1% to 4%, with a target amount of approximately 2%. Optionally, sodium citrate in an amount of 0.1% to 0.4% may be added to the shell portion slurry. After the thickener is added at step 412, the slurry may be mixed for a suitable timeframe, such as 2 to 3 minutes or more.

At step 413, gelatin is added to the shell portion slurry in an amount of approximately 2% to 7%. In some examples, the target amount of gelatin added is 4%. After gelatin is added at step 413, additional hot water in an amount of approximately 1% to 2% may be added to rinse any remaining shell portion slurry from the production equipment and flush it to the next step in method 400. After the gelatin is added at step 413, the shell portion slurry may be mixed for a suitable timeframe, such as 2 to 3 minutes or more.

At step 414, functional components are added to the shell portion slurry. The functional components may be any of the functional components described above, such as vitamins, pharmaceuticals, minerals, or other dietary supplements. The functional components added at step 414 will generally be heat tolerant and withstand being cooked at step 420. Functional components that are heat sensitive may be optionally added to the shell portion slurry at step 490 after cooking step 420.

Any suitable and desired amount of functional components may be added to the shell portion slurry at step 414. The reader can reference the functional components section above for examples of functional components that may be added at step 414. In the present example, the functional components are a blend of vitamins and are added in an amount of 2% to 35%. A functional component amount of 4.5% may be targeted to add at this stage of the method in some examples.

As shown in FIG. 5, at step 415, starch is added to the shell portion slurry. In the present example, the starch is precooked and is added in a range of 2% to 10%. In particular, adding starch in an amount approximating 4% is typical at step 415.

At step 416, sweetener is added to the shell portion slurry in an amount between 24% and 65%. In other examples, smaller quantities of sweetener are added. In some examples, no sweetener is added. When the sweetener added at step 416 is maltitol syrup, the sweetener is added in an amount approximating 60% of the shell portion formula weight. When the sweetener added is 63/43 DE glucose and sucrose syrup, the amount of the sweetener added represents approximately 24% of the shell portion.

Maltitol syrup and 63/43 DE glucose and sucrose syrup are two examples of a sweetener that may be used in methods of making chewable composition described herein. Other suitable sweetener examples include sucrose, fructose, corn syrup, and humectants in addition or alternatively to maltitol, such as sorbitol and xylitol. Any suitable known or later developed sweetener or combination of sweeteners may be used.

With reference to FIG. 4, at step 420, the shell portion is cooked at a temperature between 240° F. and 280° F. In some examples, a target temperature range for the shell portion slurry is 240° F. to 245° F. To cook the shell portion slurry at step 420, the shell portion slurry may be added to a kettle with a steam coil maintained at approximately 240° F. and 280° F. with a steam backpressure of 18-35 psi.

As shown in FIG. 4, after cooking the shell portion slurry at step 420, the shell portion slurry is cooled at step 430. Cooling at step 430 includes placing the shell portion slurry in a chamber under vacuum to promote evaporative cooling. In addition to its cooling effect, the vacuum helps remove excess moisture and air from the shell portion slurry after it is cooked at step 420. The vacuum chamber temperature may be maintained at a temperature of 155-205° F. and a pressure of 3-12 psi. In other examples, the shell portion slurry is cooled in a vessel not under vacuum, such as with conventional shell-and-tube heat exchanger equipment.

With reference to FIGS. 4 and 6, at step 440, the shell portion slurry is mixed with additional components prior to being molded at step 450. As shown in FIG. 6, second mixing step 440 includes adding colorants at step 442, adding flavorants at step 444, and adding acids at step 446. Optionally, at step 490, heat sensitive functional components may be mixed with the shell portion slurry as part of step 440.

Mixing the additional components with the shell portion slurry may involve an automatic batching system configured to mix multiple different components with discrete divisions of the shell portion slurry. For example, the automatic batching system may be configured to receive 6 different divisions of the shell portion slurry and add different additional components to each division. In some examples, 6 different colors, 6 different flavorants, and 6 different acids are added to the different: shell portion divisions at step 444.

Second mixing step 440 may include a collecting step and a homogenizing step. For example, the mixing equipment used for step 440, including each discrete batch of the automatic batching system described above, may include a collecting vessel, a homogenizing vessel, and a transfer line between the vessels.

In such an equipment configuration, the second mixing step includes receiving the shell portion slurry or discrete shell portion divisions and additional components into the collecting vessel for each division and then transferring them to the homogenizing vessel for each division. Transferring the contents of the collecting vessel through the transfer line mixes the shell portion slurry and additional components together. Once the mixed contents reach the homogenizing vessel, they can be held and allowed to homogenize until being deposited to a molding machine at step 450.

With reference to FIG. 6, adding colorants at step 442 includes adding colorants in an amount of approximately 0% to 2%. in some specific examples, colorants are added in an amount representing 0.6%. In other examples, colorants are not added as adding color to the chewable composition is optional. Suitable colors to add include red dye #40; yellow dye #5; yellow dye #6; blue dye #1, black carrot, annatto, tumeric, purple berry concentrate, and combinations thereof.

At step 444, adding flavorants includes adding an amount of flavorants representing approximately 0.2% and 0.14% of the shell portion formula weight. Suitable flavorants include mixtures of aromatic chemicals, such as methyl anthranilate and ethyl caproate, and flavoring obtained from fruits, berries, honey, molasses, maple sugar and the like. Other suitable flavorants include corn syrup, sucrose, or sucralose.

At step 446, acids are added to the shell portion slurry. The amount of acids may be between 0.02% and 0.20%. Suitable acids include citric acid, lactic acid, fumaric acid, malic acid, ascorbic acid and the like.

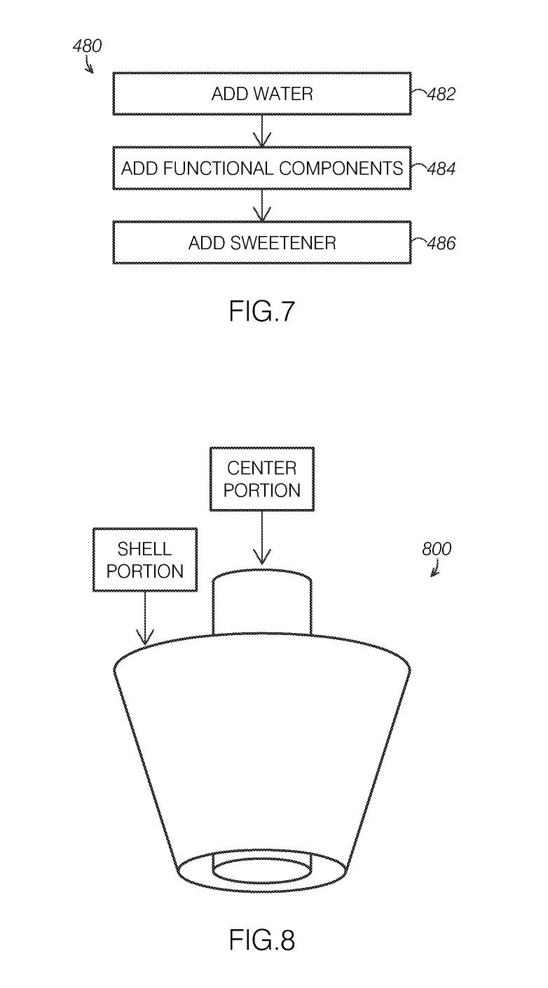

Before describing molding step 440, which involves molding both the shell portion and the center portion concurrently, reference will be made to mixing together the center components at step 480 in FIGS. 4 and 7. As shown in FIG. 7, mixing the center components to form a center portion slurry at step 480 includes adding water at step 482, adding functional components at step 484, and adding sweetener at step 486. Step 480 may be performed with steam jacketed kettles and transfer lines maintained at 180-200° F.

Adding water at step 482 may include heating the water to around 185° F., which has

been observed to help mix together the components added at step 480. The amount of water added at step 411 may be approximately 18% of the formula weight of the center portion.

At step 484, any suitable amount and type of functional components may be added to the center portion slurry. The reader can reference the functional components section above for examples of functional components that may be added at step 484. In the present example, the functional components are a blend of vitamins and are added in an amount of approximately 0% to 50%) of the center portion formula weight. A functional component amount of approximately 10% may be targeted to add to the center portion slurry.

At step 486, sweetener is added to the center portion slurry in an amount representing approximately 72% of the center portion formula weight. In other examples, smaller quantities of sweetener are added. In some examples, no sweetener is added.

The sweetener added at step 486 may be a mixture of sucrose and glucose syrup. For example, the sweetener is a mixture of 43/43 DE glucose syrup and sucrose in some examples. The glucose syrup may be approximately 43% and the sucrose may be approximately 29% of the center portion slurry formula weight.

Additionally or alternatively, other sweeteners may be added to the center portion slurry. For example, suitable sweeteners include syrup, fructose, corn syrup, and humectants, such as sucralose, sorbitol, maltitol, and xylitol. Other suitable sweeteners include fruit juice, vegetable juice, fruit puree, fruit pulp, vegetable pulp, vegetable puree, fruit sauce, vegetable sauce, honey, maple syrup, molasses, corn syrup, sugar syrup, polyol syrup, hydrogenated starch hydrolysates syrup, emulsions, vegetable oil, glycerin, propylene glycol, ethanol, liqueurs, sorbitol or any other liquid sweetener, dairy-based liquids such as milk or cream, or any combination thereof. Any suitable known or later developed sweetener or combination of sweeteners may be used.

With reference to FIGS. 4 and 8, molding step 450 will now be described. To mold chewable compositions at step 450, a starch depositor or molding machine may be used. However, in other examples, molding processes that do not include starch are utilized.

For example, rigid or permanent molds may be used as an alternative to starch molding processes. When rigid or permanent molds are used, the outer and inner portion slurries may be deposited into the rigid mold and the slurry may be allowed to cure in the mold until a desired firmness is achieved yielding a chewable composition. Once the chewable composition is removed from the rigid mold, the mold may be rinsed, steam cleaned, or otherwise prepared to receive another batch of slurry.

When a starch molding process is utilized, any conventional or later developed starch molding machine, commonly referred to as a Mogul, may be used. Persons skilled in the chewable composition art know that a Mogul is a starch molding machine that automatically performs multiple starch related molding steps to mold chewable compositions. Molding chewable compositions with a Mogul may be conducted in batches or on a continuous basis.

Starch has multiple roles in a starch molding process to form chewable compositions. For example, the starch restricts or prevents the chewable composition slurry from sticking to the mogul boards, which allows the resulting chewable composition to be more easily separated from the mogul boards. Further, starch maintains the chewable composition slurry in place during the drying, cooling, and setting processes. In addition, starch absorbs moisture from the chewable composition, which helps give it a desired texture.

The starch used in the molding process may be recycled to consume less starch and thereby to make the molding process more economical. Recycling starch involves collecting starch that falls away from the chewable composition when they are removed from the mogul boards. Further, recycling starch may include sending the collected starch to a dryer where it is sifted and dried.

After the collected starch is dried, it may then be cooled in a starch cooler. The cooled starch may be sifted a second time and returned to the Mogul where it may be re-circulated once again, through the same process. To complete the recycling process, the starch may be sprayed evenly on the mogul board again to receive more slurry in a subsequent molding process.

To start the molding process with a Mogul, the chewable composition slurry is deposited by depositors, such as filling nozzles, onto starch lined trays, which are commonly known as mogul boards. The mogul boards are imprinted in various shapes to define the ultimate shape of the chewable composition. After the slurry is deposited on a mogul board and allowed to set, the slurry will firm up and take the shape imprinted into the mogul board to form a chewable composition in a predetermined shape. The depositors may be limed to automatically deliver a set amount of slurry to fill the trays as the mogul boards are passed under the depositors.

In the example shown in FIG. 4, molding step 450 includes concurrently depositing the shell portion slurry and the center portion slurry into cornstarch molds. In other examples, the shell portion slurry is deposited into cornstarch molds first and the center portion slurry is introduced into the shell portion slurry at a later time, such as by injecting the center portion slurry into the shell portion deposited into the mold. In other examples, the center portion slurry is deposited into a mold first and the shell portion slurry is layered onto the center portion slurry later, such as by pouring the shell portion slurry over the center portion slurry.

FIG. 8 depicts a nozzle 800 configured to concurrently deposit the shell portion slurry and the center portion slurry. As shown in FIG. 8, the shell portion slurry may be fed to the outside annular region of nozzle 800 and the center portion slurry may be fed to the center of nozzle 800. Appropriate pumps or pistons may be fed appropriate quantities of the slurries to the nozzle as needed.

Concurrently depositing the shell portion slurry and the center portion slurry at step 450 may include depositing a portion of shell portion slurry through nozzle 800 into a cornstarch mold to form a base, depositing center portion slurry onto the base of shell portion slurry with nozzle 800, and then depositing more shell portion slurry with nozzle 800 around the center portion slurry just deposited to form a shell around center portion slurry.

The chewable composition slurry may be molded into a wide variety of shapes at step 450. For example, the chewable composition may be molded into the shape of spheres, cubes, boxes, coin shaped compositions, gumdrop or raindrop shapes, pyramids, disks, and irregular shapes. Further suitable shapes include life-form based shapes, such as animals, including bears, worms, or fish; plants, trees, or flowers; or people. Other suitable shapes include shapes of objects, such as cars, houses, mountains, cell phones, or money.

As shown in FIG. 4, after molding the chewable composition at step 450, the chewable composition is conditioned at step 460. Conditioning the chewable composition at step 460 may include cleaning, glazing, or sanding the chewable composition. To sand the chewable composition with sugar and/or citric acid, the chewable composition may be steamed to form a condensation layer on its outer surface. The condensation layer helps the sugar and/or citric acid adhere to the outer surface of the chewable composition. In examples where the chewable composition is sanded, it may be cooled, such as by passing it through a cooling tunnel, after sanding to remove moisture from the sugar, which might otherwise form wet spots.

Conditioning the chewable composition at step 460 includes drying the composition at 60° F. to 140° F. for 12 to 24 hours. The drying process may involve gradually reducing the temperature of the air surrounding the composition over time. The relative humidity of the air surrounding the chewable composition may be set to approximately 20-30% relative humidity to facilitate the drying process.

As shown in FIG. 4, the final step of method 400 is a finishing step 470. Finishing step 470 may include sorting the chewable compositions, batching the chewable compositions, and bottling the chewable compositions. Sorting the chewable compositions produced by method 400 allows for filtering out chewable compositions that do not meet quality control standards, such as having aesthetic blemishes or being misshapen, before they are bottled. Batching the chewable compositions may include weighing out predetermined quantities, such as 20 pound batches, to be fed into the bottling process. Bottling the chewable compositions may utilize any conventional or later developed bottling or packaging process, such as those that bottle product into blister cards, bags, or pouches.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A chewable composition comprising:
an inner portion in the form of a liquid, semi-liquid, or gel and including at least one inner functional component; and
an outer portion comprised of a hydrocolloid base including at least one outer functional component;
wherein the inner portion is surrounded by the outer portion.

2. The chewable composition of claim 1, wherein the outer functional component is the same as the inner functional component.

3. The chewable composition of claim 1, wherein the outer functional component is complementary to the inner functional component.

4. The chewable composition of claim 1, wherein the inner functional component is vitamin C and further wherein the outer portion inhibits furfural production.

5. The chewable composition of claim 1, wherein the outer portion substantially blocks light from the inner portion.

6. The chewable composition of claim 1, wherein the potency of the inner functional component is reduced at temperatures greater than 240° F.

7. The chewable composition of claim 1, wherein die chewable composition is configured to be chewed and swallowed in less than about 20 seconds.

8. The chewable composition of claim 1, wherein the inner portion is about 5 to about 60 weight percent of the chewable composition.

9. The chewable composition of claim 1, wherein the chewable composition has a total weight from about 2 grams to about 10 grams.

10. The chewable composition of claim 1, wherein the weight of the outer functional component is from about 5 to about 60 percent of the weight of the outer portion.

11. The chewable composition of claim 1, wherein the weight of the inner functional component is from about 5 to about 60 percent of the weight of the inner portion.

12. The chewable composition of claim 1, wherein the inner portion has an inner water activity that is similar to an outer water activity of the outer portion to limit components of the inner portion and the outer portion migrating between the inner portion and the outer portion.

13. The chewable composition of claim 1, wherein the outer portion is embossed with indicia.

14. The chewable composition of claim 13, wherein the indicia provides information about the inner functional component.

15. A chewable composition, comprising:
a shell portion comprised of a gelatin, pectin, and starch matrix and a first functional component;
a center portion comprised of a liquid, semi-liquid, or gel and including a second functional component;
wherein the center portion is enclosed by the shell portion and further wherein a first water activity of the shell portion and a second water activity of the center portion are similar.

16. The chewable composition of claim 15, wherein the shell portion substantially protects the center portion from one or more of exposure to light and oxidation.

17. The chewable composition of claim 15, wherein the weight of the gelatin is from about 1 to about 10 percent of the weight of shell portion, the weight of the pectin is from about 1 to about 5 percent of the weight of the shell portion, and the weight of the starch is from about 3 to about 10 percent of die weight of the shell portion.

18. A chewable hydrocolloid-based supplement comprising:
an inner portion comprised of a liquid, semi-liquid, or gel and including an inner functional component comprising a dietary supplement or drug; and
an outer portion comprised of a hydrocolloid-base including an outer functional component;
wherein:
the inner portion has a volume ranging between 0.25 ml and 1.25 ml:
the outer portion houses the inner portion and protects the inner functional component from exposure to oxygen and moisture;
a first density of the outer portion and a second density of the inner portion are substantially different.

19. The chewable hydrocolloid-based supplement of claim 18, wherein the first density of the outer portion and the second density of the center portion are between 10% and 20% of one another.

20. The chewable hydrocolloid-based supplement of claim 18, wherein the inner functional component and the outer functional component combine to total greater than 250 milligrams of omega-3 fatty acid.
